(19) United States
(12) Patent Application Publication
(10) Pub. No.: US 2019/0212676 A1
(43) Pub. Date: Jul. 11, 2019

(54) IMAGE FORMING APPARATUS AND IMAGE FORMING METHOD

(71) Applicant: TOSHIBA TEC KABUSHIKI KAISHA, Tokyo (JP)

(72) Inventor: Masaya TANAKA, Sunto Shizuoka (JP)

(21) Appl. No.: 16/109,189

(22) Filed: Aug. 22, 2018

(30) Foreign Application Priority Data
Jan. 11, 2018 (JP) 2018-002925

(51) Int. Cl. G03G 15/20

(52) U.S. Cl. CPC G03G 15/2039; G03G 2215/2016; G03G 15/2053

(57) ABSTRACT

In accordance with an embodiment, an image forming apparatus comprises a fixing device, an inductive heater configured to heat the fixing device, and a magnetic shunt alloy disposed at an inner surface of the fixing device. A temperature detector is configured to detect a temperature of the magnetic shunt alloy. A thermostat contacting the magnetic shunt alloy is configured to shut off electric power to the inductive heater when the thermostat reaches or exceeds a first threshold temperature value. A controller is configured to reduce electric power to the inductive heater if the detected temperature of the magnetic shunt alloy is equal to or higher than a second threshold temperature value lower than the first threshold temperature value.

### CROSS-REFERENCE TO RELATED APPLICATION

This application is based upon and claims the benefit of priority from Japanese Patent Application No. 2018-002925, filed Jan. 11, 2018, the entire contents of which are incorporated herein by reference.

### FIELD

Embodiments described herein relate to an image forming apparatus and an image forming method.

### BACKGROUND

An image forming apparatus includes a fixing belt that fixes an image on a sheet, a thermostat, which includes a bimetal component, and a magnetic shunt alloy contacting the thermostat. The thermostat cuts off electric power supplied to a heating section used to heat the fixing belt if a temperature of the fixing belt becomes too high. Even when the temperature of the fixing belt is normal, if the temperature of the magnetic shunt alloy reaches or exceeds the Curie temperature (Curie point), the thermostat may break.

In a conventional image forming apparatus, by reducing the temperature of the fixing belt, it is possible to prevent the thermostat from breaking. However, when the temperature of the fixing belt is lowered, there is a possibility that the image will not be appropriately fixed on the sheet since the fixing belt has relatively small heat capacity. There is a case in which the conventional image forming apparatus fails to prevent the thermostat from breaking.

### DESCRIPTION OF THE DRAWINGS

FIG. 1 is an external view illustrating an example of an overall configuration of an image forming apparatus according to an embodiment.

FIG. 2 is a block diagram illustrating an example of hardware configuration of the image forming apparatus according to an embodiment.

FIG. 3 is a diagram illustrating an example of a configuration of a fixing device according to an embodiment.

FIG. 4 is a diagram illustrating an example of a data table including a plurality of setting values according to an embodiment.

FIG. 5 is a flowchart for depicting an operation example of the image forming apparatus according to an embodiment.

### DETAILED DESCRIPTION

In accordance with an embodiment, an image forming apparatus comprises a fixing device, which may include or be a fixing belt, an inductive heater configured to heat the fixing device, and a magnetic shunt alloy disposed at an inner surface of the fixing device. A temperature detector is configured to detect a temperature of the magnetic shunt alloy. A thermostat contacting the magnetic shunt alloy is configured to shut off electric power to the inductive heater when the thermostat reaches or exceeds a first threshold temperature value. A controller is configured to reduce electric power to the inductive heater if the detected temperature of the magnetic shunt alloy is equal to or higher than a second threshold temperature value lower than the first threshold temperature value.

Hereinafter, an image forming apparatus and an image forming method of certain example embodiments will be described with reference to the accompanying drawings. The scope of the present disclosure is not limited to these examples.

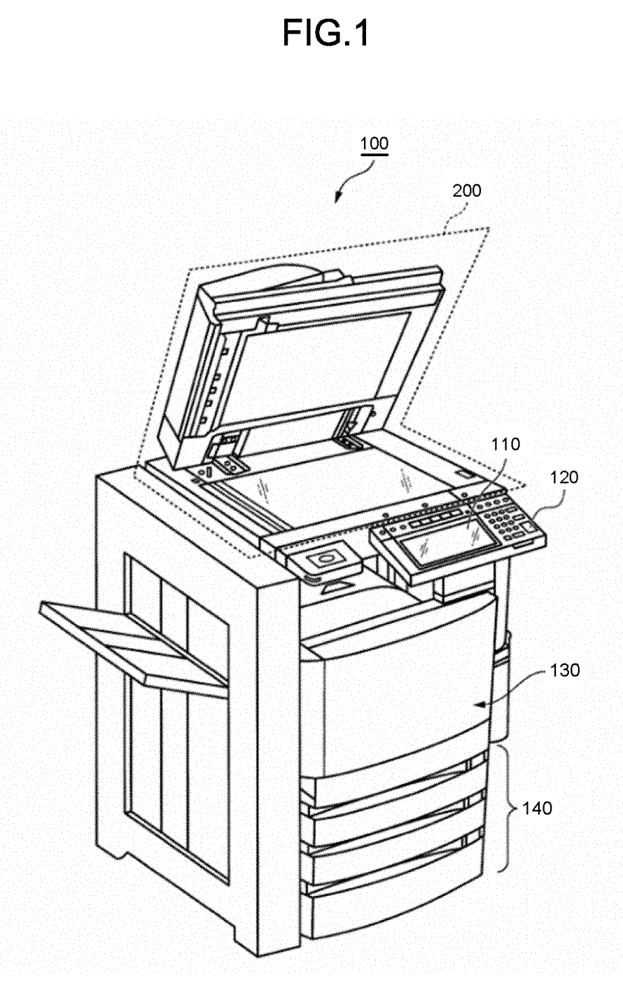

FIG. 1 is an external view illustrating an example of an overall configuration of an image forming apparatus 100. For example, the image forming apparatus 100 is a multi-functional peripheral (MFP) device. The image forming apparatus 100 includes a display 110, a control panel 120, a printer 130, a sheet housing section 140 and an image reading section 200. The printer 130 may be a device for fixing a toner image or an inkjet type device.

In this example, the image forming apparatus 100 forms an image on a sheet with a developer such as a toner. The sheet is, for example, paper or label stock. Any sheet-type recording medium can be used for the image formation as long as the image forming apparatus 100 can form an image on a surface thereof.

The display 110 is an image display device such as a liquid crystal display, an organic EL (Electro Luminescence) display (OLED) and the like. The display 110 displays various information relating to the image forming apparatus 100.

The control panel 120 includes a plurality of buttons or the like. The control panel 120 receives inputs from a user. The control panel 120 outputs a signal in response the user input(s). The display 110 and the control panel 120 may be integrated as a touch panel.

The printer 130 forms an image on the sheet based on image information generated by the image reading section 200 or image information received through a communication path (e.g., network connection). In this example, an image forming section of the printer 130 forms an electrostatic latent image on a photoconductive drum based on received image information. The image forming section of the printer 130 forms a visible image by supplying developer to the electrostatic latent image. Toner is provided as or with developer. A transfer section of the printer 130 transfers the visible image onto the sheet. A fixing section of the printer 130 fixes the visible image on the sheet by heating and pressing the sheet. The sheet on which the image is formed may be a sheet supplied from the sheet housing section 140 or manually fed.

The sheet housing section 140 houses the sheet(s) to be subjected to the image formation processing in the printer 130.

The image reading section 200 reads image information from an original copy according to an intensity of reflected light or the like from the original copy. The image reading section 200 records the image information that is read from the original copy. In some examples, the recorded image information may be transmitted to another information processing apparatus via a network. The recorded image information from the image reading section 200 may be used by the printer 130 to form an image on the sheet.

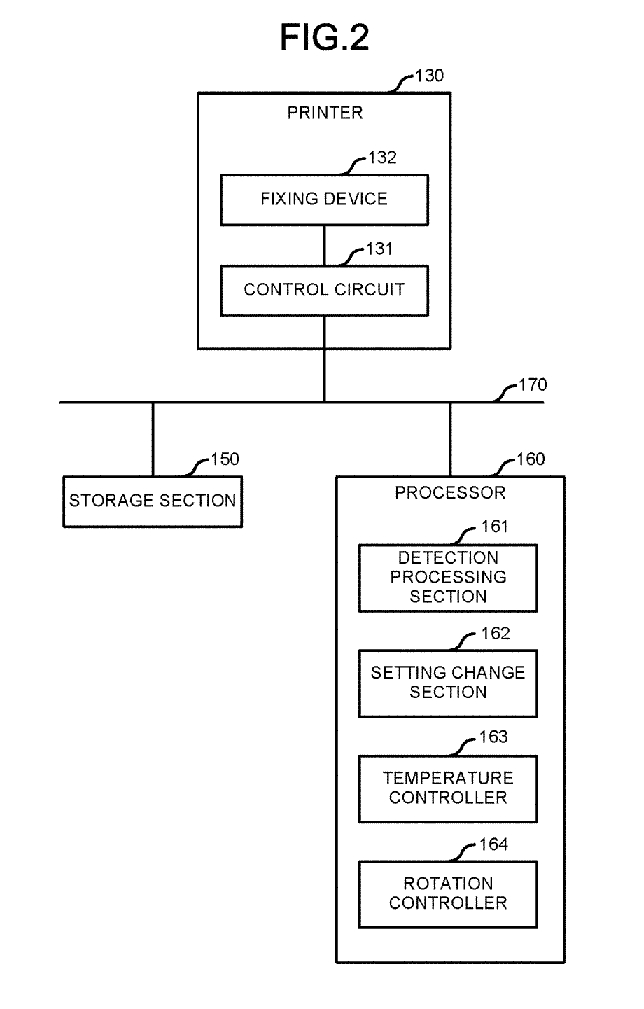

FIG. 2 is a block diagram illustrating an example of hardware configuration of the image forming apparatus 100. The image forming apparatus 100 comprises the printer 130, a storage section 150, a processor 160, and a bus 170. The bus 170 transfers data between functional sections of the image forming apparatus 100.

The printer 130 includes a control circuit 131 and a fixing device 132. The control circuit 131 controls the operation of the fixing device 132. The control circuit 131 includes a motor driving circuit for causing the fixing belt and the pressure roller of the fixing device 132 to rotate. The control circuit 131 controls the operation of the fixing device 132 under the overall control of the processor 160. For example, the control circuit 131 controls a rotation speed of the motor for rotating the fixing belt in the fixing device 132.

The control circuit 131 receives a signal indicating the rotation speed of the fixing belt from the motor. The control circuit 131 in turn outputs a signal indicating the rotation speed of the fixing belt to the processor 160. The control circuit 131 also receives signals from thermistors provided in the fixing device 132 corresponding to the temperature at the thermistors. The control circuit 131 outputs a signal indicating temperature in the fixing device 132 to the processor 160.

The control circuit 131 acquires a setting value from the processor 160 for the electric power supplied of an induction heating (IH) coil, which is referred to as “coil power setting value”. The control circuit 131 supplies the electric power to the IH coil according to the coil power setting value. The control circuit 131 acquires a setting value from the processor 160 for the rotation speed of the fixing belt, which is referred to as a “belt speed setting value”. The control circuit 131 supplies electric power to the motor to rotate the fixing belt and the pressure roller according to the belt speed setting value.

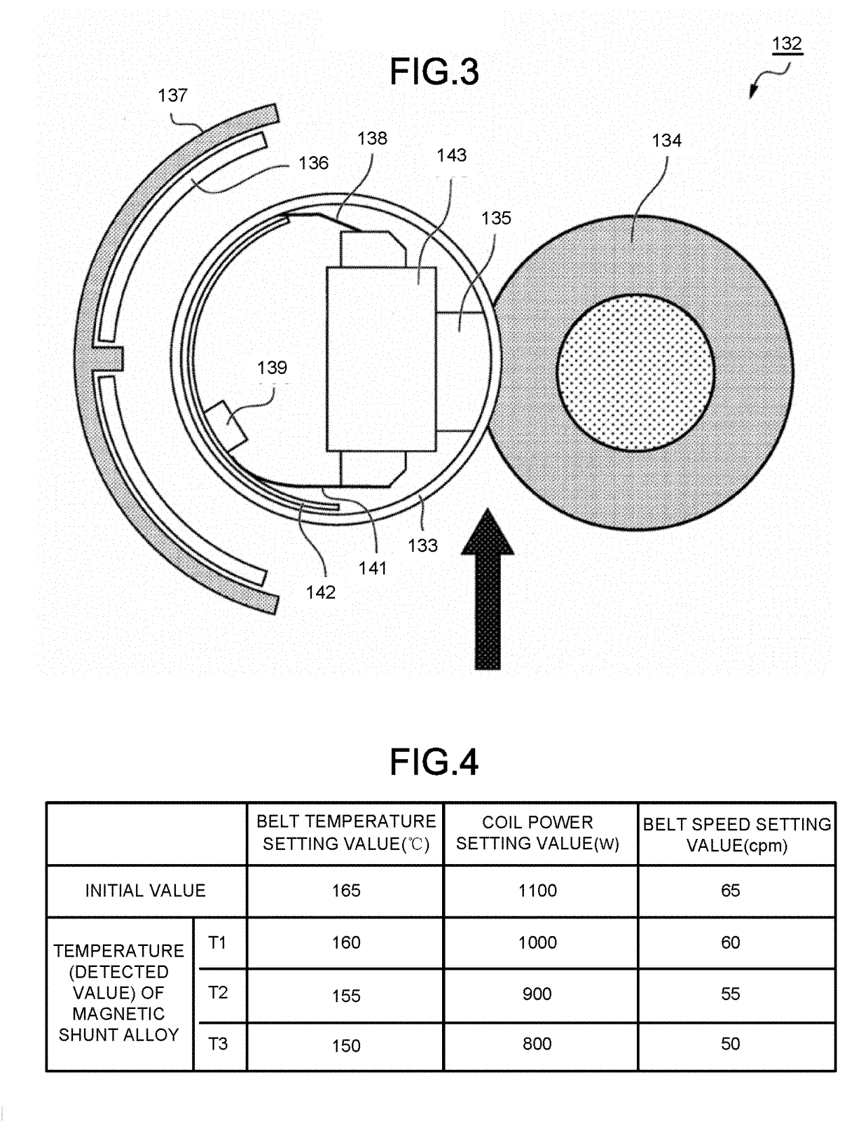

FIG. 3 is a diagram illustrating an example configuration of a fixing device 132. The fixing device 132 fixes an image, such as a toner image, onto a sheet. The fixing device 132 includes fixing belt 133, pressure roller 134, pressure pad 135, IH coil 136, ferrite core 137, thermistor 138, thermostat 139, thermistor 141, magnetic shunt alloy 142, and support section 143. The large arrow shown in FIG. 3 indicates a conveyance direction (sheet travel direction) for the sheet during printing.

The fixing belt 133 rotates in response to the rotation of the pressure roller 134. For example, the fixing belt 133 includes a base layer, such as a polyimide film, a heat generation layer made of a nonmagnetic metal, such as nickel or copper, and a heat-resistant elastic layer, such as silicone rubber. The heat generation layer generates heat via magnetic induction resulting from the alternating current of the applied electric power supplied to the IH coil 136. The fixing belt 133 may be covered or coated with fluoropolymer having a high release property (“non-stick” characteristic). A fixing nip is formed between the fixing belt 133 and the pressure roller 134. The fixing belt 133 fixes the image on the sheet at the fixing nip. The rotation speed of the fixing belt 133 can be adjusted by the processor 160 so as to prevent fixing failures from occurring.

The pressure roller 134 is provided with a heat resistant elastic layer, such as a silicone-based sponge, over a central core. Like the fixing belt 133, the pressure roller 134 may be covered or coated with a fluoropolymer. Thereby, the release property of the pressure roller 134 can be improved. The fixing nip is formed between the fixing belt 133 and the pressure roller 134 by pressing with the pressure pad 135 against the pressure roller 134.

The pressure pad 135 is a pad member made of heat resistant resin. The pressure pad 135 is supported by the support section 143 inside the space surrounded by the fixing belt 133.

The IH coil 136 heats the fixing belt 133 by the magnetic induction. The electric power supplied to the IH coil 136 is adjusted by the processor 160 so as to prevent the fixing failures.

The ferrite core 137 is outside of the fixing belt 133. The ferrite core 137 serves to concentrate the magnetic flux generated by the IH coil 136 onto the fixing belt 133.

The thermistor 138 is within the space surrounded by the fixing belt 133. The thermistor 138 detects a temperature of the fixing belt 133.

The thermostat 139 includes a bimetal. The thermostat 139 contacts the magnetic shunt alloy 142 and both are within the space surrounded by the fixing belt 133. The heat of the magnetic shunt alloy 142 is transmitted to the thermostat 139.

Since the size of the thermostat 139 is limited, it is difficult to provide a thermocouple within the thermostat 139. In general, it is not possible to provide a thermocouple in the thermostat 139 in an easily mass-produced manner. But if a thermocouple is not provided in the thermostat 139, it becomes difficult to directly detect the temperature in the thermostat 139. Therefore, instead of directly detecting the temperature of the thermostat 139, the thermistor 141 is used to detect the temperature of the magnetic shunt alloy 142 that is in contact with the thermostat 139.

The thermostat 139 cuts off the electric power supplied to the IH coil 136 when the temperature of the fixing belt 133 becomes equal to or higher than some cutoff threshold value. As a result, the thermostat 139 can stabilize the temperature of the fixing belt 133 in the vicinity of the magnetic shunt alloy 142.

The Curie temperature of the magnetic shunt alloy 142 is, for example, about 220 to 230° C., and varies depending on the particular material used for the magnetic shunt alloy 142. In some instances, the Curie temperature of the magnetic shunt alloy 142 may be lower than the cutoff threshold value temperature at which the electric power supplied to the IH coil 136 is cut off by the thermostat 139.

The magnetic shunt alloy 142 has an arc shape. The magnetic shunt alloy 142 is arranged on the inner side of the fixing belt 133 and matches to the shape of the fixing belt 133 along some portion of the fixing belt 133. The magnetic shunt alloy 142 is heated by the magnetic induction of the IH coil 136. Thereby, the magnetic shunt alloy 142 can assist in heating of the fixing belt 133. The magnetic shunt alloy 142 can also prevent the temperature of the fixing belt 133 from abnormally rising.

The magnetic property of the magnetic shunt alloy 142 sharply changes near its Curie temperature. If the temperature of the magnetic shunt alloy 142 is lower than the Curie temperature, magnetic permeability of the magnetic shunt alloy 142 shows the characteristics of a ferromagnetic material. In general, the rise in the temperature for the magnetic shunt alloy 142 is gentler than that of the temperature of the thermostat 139. The higher the temperature of the magnetic shunt alloy 142 becomes, the higher the magnetic permeability of the magnetic shunt alloy 142 becomes. However, when the temperature of the magnetic shunt alloy 142 closely approaches the Curie temperature, the magnetic permeability of the magnetic shunt alloy 142 begins to sharply decrease.

When the temperature of the magnetic shunt alloy 142 reaches the Curie temperature, the magnetic permeability of the magnetic shunt alloy 142 becomes very low. If the magnetic permeability is very low, induced current will not be generated in magnetic shunt alloy 142. If the induced current of the magnetic shunt alloy 142 is not generated, there is a possibility that the thermostat 139 may generate additional heat due to the magnetic induction of the IH coil 136 and ultimately break. To prevent the thermostat 139 from breaking, the processor 160 reduces the electric power supplied to the IH coil 136 such that the temperature of the magnetic shunt alloy 142 does not reach the Curie temperature. The electric power supplied to the IH coil 136 is adjusted by the processor 160, thereby adjusting the temperature of the magnetic shunt alloy 142.

Returning again to FIG. 2, the description of an example of the hardware configuration of the image forming apparatus 100 is continued. The storage section 150 has a nonvolatile storage medium (non-transitory storage medium), such as a flash memory and/or a HDD (Hard Disk Drive). The storage section 150 may further include a RAM (Random Access Memory). The storage section 150 stores programs to be executed by the processor 160. The storage section 150 further stores a data table including a plurality of setting values.

FIG. 4 is a diagram illustrating an example of the data table including a plurality of setting values. In the data table, a setting value of the temperature of the fixing belt (“BELT TEMPERATURE SETTING VALUE (° C.)”), the coil power setting value (“COIL POWER SETTING VALUE (W)”), and the belt speed setting value (“BELT SPEED SETTING VALUE (cpm)”) are associated with each other. An initial value of the belt temperature setting value is 165° C. An initial value of the coil power setting value is 1100 W. An initial value of the belt speed setting value is 65 cpm.

When the temperature of the fixing belt 133 and the temperature of the magnetic shunt alloy 142 are to be lowered, the belt temperature setting value, the coil power setting value, and the belt speed setting value are changed to values lower than the respective initial values. For example, since the electric power supplied to the IH coil 136 decreases as the coil power setting value decreases, the temperature of the fixing belt 133 and the temperature of the magnetic shunt alloy 142 will decrease.

When the detected temperature of the magnetic shunt alloy 142 is value T1, the belt temperature setting value is 160° C., the coil power setting value is 1000 W, and the belt speed setting value is 60 cpm. When the detected temperature) of the magnetic shunt alloy 142 is value T2, the belt temperature setting value is 155° C., the coil power setting value is 900 W, and the belt speed setting value is 55 cpm. Similarly, when the detected temperature of the magnetic shunt alloy 142 is a value T3, the belt temperature setting value is 150° C., the coil power setting value is 800 W, and the belt speed setting value is 50 cpm. These setting values are merely examples and not requirements.

Thus, in accordance with the detected temperature of the magnetic shunt alloy 142, the processor 160 can change the setting values only as necessary. Specifically, the processor 160 can reduce the temperature and rotation speed of the fixing belt 133. Since a plurality of threshold values, such as the values T1, T2 and T3, are defined in the data table, the processor 160 can change the respective setting values in stages. The processor 160 can efficiently fix the visible image on the sheet by changing each setting value.

Returning again to FIG. 2, the description of an example of the hardware configuration of the image forming apparatus 100 is continued. The processor 160 is a CPU (Central Processing unit) or the like. The processor 160 executes the program stored in the storage section 150. A part of the process performed by the processor 160 may be realized by using hardware such as a LSI (Large Scale Integration) or an ASIC (Application Specific Integrated Circuit).

The processor 160 includes a detection processing section 161, a setting change section 162, a temperature controller 163, and a rotation controller 164. The detection processing section 161 detects the temperature of the magnetic shunt alloy 142.

The setting change section 162 acquires the data table stored in the storage section 150. The setting change section 162 initializes the belt temperature setting value, the coil power setting value, and the belt speed setting value based on the data table. The setting change section 162 changes the belt temperature setting value, the coil power setting value, and the belt speed setting value to respective setting values corresponding to the particular detected temperature value for the magnetic shunt alloy 142. For example, when the detected temperature of the magnetic shunt alloy 142 is T1, the setting change section 162 changes the belt temperature setting value to 160 degrees ° C., the coil power setting value to 1000 W, the belt speed setting value to 60 cpm, according to the values stored in the data table. Since a plurality of threshold values (such as the values T1, T2 and T3) can be provided in the data table, the setting change section 162 can change the respective setting values in a plurality of stages.

The temperature controller 163 outputs a signal indicating the coil power setting value to the control circuit 131. Thereby, the temperature controller 163 can supply the electric power corresponding to the coil power setting value to the IH coil 136 through the control circuit 131. The temperature controller 163 reduces the electric power supplied to the IH coil 136 as the temperature of the magnetic shunt alloy 142 rises.

The rotation controller 164 outputs a signal indicating the belt speed setting value to the control circuit 131. As a result, the rotation controller 164 can rotate the fixing belt 133 and the pressure roller 134 at the rotation speed corresponding to the belt speed setting value. The rotation controller 164 lowers the rotation speed of the fixing belt 133 and the pressure roller 134 as the temperature of the magnetic shunt alloy 142 rises.

Next, an example of the operation of the image forming apparatus 100 is described.

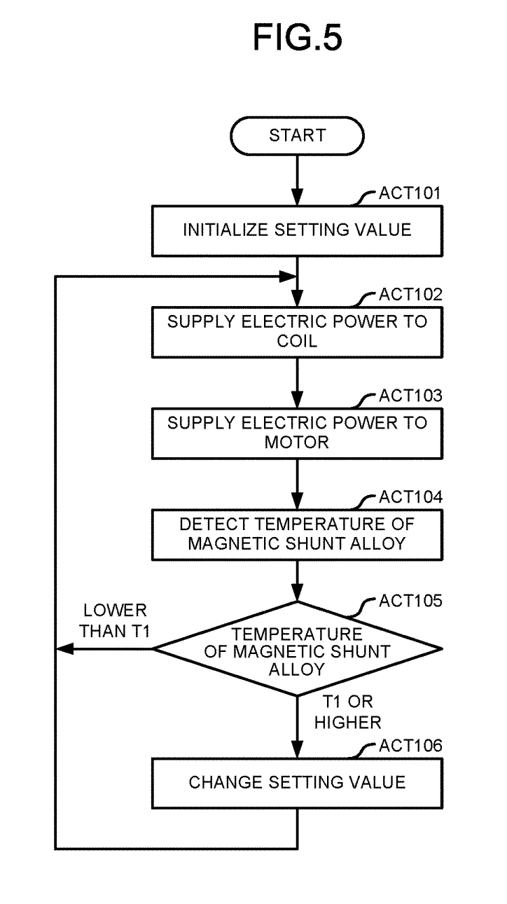

FIG. 5 is a flowchart for depicting an example of the operation of the image forming apparatus 100. The setting change section 162 initializes the belt temperature setting value, the coil power setting value, and the belt speed setting value (ACT 101).

The temperature controller 163 outputs the signal indicating the coil power setting value to the control circuit 131. The control circuit 131 supplies the electric power corresponding to the coil power setting value to the IH coil 136 (ACT 102). The rotation controller 164 outputs the signal indicating the belt speed setting value to the control circuit 131. The control circuit 131 supplies the electric power corresponding to the belt speed setting value to the motor that rotates the fixing belt 133 and the pressure roller 134 (ACT 103).

The detection processing section 161 detects the temperature of the magnetic shunt alloy 142 (ACT 104). The detected temperature is used by the temperature controller 163 and the rotation controller 164 to determine whether or not the temperature of the magnetic shunt alloy 142 is T1 or higher (ACT 105). If the temperature of the magnetic shunt alloy 142 is less than T1 (ACT 105: less than T1), the temperature controller 163 outputs a signal indicating the coil power setting value (as previously set) to the control circuit 131. The control circuit 131 supplies the electric power corresponding to the coil power setting value to the IH coil 136.

If the temperature of the magnetic shunt alloy 142 is equal to or higher than T1 (ACT 105: T1 or higher), the setting change section 162 changes the belt temperature setting value, the coil power setting value, and the belt speed setting value to respective setting values corresponding to the detected temperature of the magnetic shunt alloy 142 in the data table (ACT 106). The temperature controller 163 outputs a signal indicating the new coil power setting value to the control circuit 131. The control circuit 131 supplies the electric power corresponding to the coil power setting value to the IH coil 136.

As described above, the image forming apparatus 100 includes the fixing belt 133, the IH coil 136, the magnetic shunt alloy 142, the thermostat 139 in contact with the magnetic shunt alloy 142, the detection processing section 161, and the temperature controller 163. The IH coil 136 heats the fixing belt 133 using the electric power. The detection processing section 161 detects the temperature of the magnetic shunt alloy 142 provided at the inner side of the fixing belt 133. The temperature controller 163 reduces the electric power supplied to the IH coil 136 when the temperature of the magnetic shunt alloy 142 is equal to or higher than the threshold value T1.

According to at least one embodiment described above, if the temperature of the magnetic shunt alloy 142 is equal to or higher than the threshold value T1, it is possible to prevent the thermostat from breaking while suppressing the occurrence of the fixing failure of the visible image on the sheet by providing a temperature controller 163 that reduces the electric power supplied to the IH coil 136.

Even if the image forming apparatus 100 cannot directly detect the temperature of the thermostat 139, it is possible to prevent the temperature of the thermostat 139 from abnormally rising by monitoring the temperature of the magnetic shunt alloy 142 in contact with the thermostat 139. It is possible to efficiently fix the visible image on the sheet since it is not necessary to lower the temperature and the rotation speed of the fixing belt 133 in advance of when it becomes necessary.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image forming apparatus, comprising:
a fixing device;
an inductive heater configured to heat the fixing device;
a magnetic shunt alloy disposed at an inner surface side of the fixing device;
a temperature detector configured to detect a temperature of the magnetic shunt alloy;
a thermostat contacting the magnetic shunt alloy and configured to shut off electric power to the inductive heater when the thermostat reaches or exceeds a first threshold temperature value; and
a controller configured to reduce electric power to the inductive heater if the detected temperature of the magnetic shunt alloy is equal to or higher than a second threshold temperature value lower than the first threshold temperature value.

2. The image forming apparatus according to claim 1, wherein the controller is further configured to lower a rotation speed of the fixing device if the detected temperature of the magnetic shunt alloy is equal to or higher than the second threshold temperature value.

3. The image forming apparatus according to claim 2, wherein the controller is configured to reduce the electric power supplied to the inductive heater in stages corresponding to a plurality of threshold temperature values, each lower than the first threshold temperature value, for the detected temperature of the magnetic shunt alloy.

4. The image forming apparatus according to claim 3, wherein the controller is configured to lower the rotation speed of the fixing device in stages corresponding to the plurality of threshold temperature values for the detected temperature of the magnetic shunt alloy.

5. The image forming apparatus according to claim 2, wherein the controller is configured to lower the rotation speed of the fixing device in stages corresponding to a plurality of threshold temperature values, each lower than the first threshold temperature value, for the detected temperature of the magnetic shunt alloy.

6. The image forming apparatus according to claim 1, wherein the controller is configured to reduce the electric power supplied to the inductive heater in stages corresponding to a plurality of threshold temperature values, each lower than the first threshold temperature value, for the detected temperature of the magnetic shunt alloy.

7. The image forming apparatus according to claim 1, wherein the controller is configured to lower the rotation speed of the fixing device in stages corresponding to a plurality of threshold temperature values, each lower than the first threshold temperature value, for the detected temperature of the magnetic shunt alloy.

8. The image forming apparatus according to claim 1, wherein the inductive heater comprises a coil and a ferrite core, the coil being disposed between the ferrite core and the fixing belt.

9. The image forming apparatus according to claim 1, wherein the temperature detector comprises a thermistor.

10. The image forming apparatus according to claim 1, wherein the temperature detector comprises a first thermistor detecting a temperature of the fixing device and a second thermistor detecting a temperature of the magnetic shunt alloy.

11. The image forming apparatus according to claim 1, wherein the thermostat comprises a bimetal component.

12. The image forming apparatus according to claim 1, wherein the magnetic shunt alloy has an arc shape corresponding to a portion of the inner surface of the fixing device.

13. A fixing device for a printer, comprising:
a fixing belt;
a magnetic shunt alloy disposed within a space surrounded by of the fixing belt and having an arc shape corresponding to an inner surface of the fixing belt;
an inductive heater disposed outside of the space surrounded by fixing belt and configured to heat the fixing belt by magnetic coupling to the magnetic shunt alloy;
a first thermistor configured to detect a temperature of the magnetic shunt alloy;
a second thermistor configured to detect a temperature of the fixing belt;
a thermostat contacting a inner surface of the magnetic shunt alloy and configured to shut off power the inductive heater when the thermostat reaches or exceeds a first threshold temperature value; and
a controller configured to reduce power to the inductive heater if the detected temperature of the magnetic shunt alloy is equal to or higher than a second threshold temperature lower than the first threshold temperature value.

14. The fixing device according to claim 13, wherein the controller is further configured to output a signal to cause a rotation speed of the fixing belt to be lowered if the detected temperature of the magnetic shunt alloy is equal to or higher than the second threshold temperature value.

15. The fixing device according to claim 14, wherein the controller is configured to lower the rotation speed of the fixing belt in stages corresponding to the plurality of threshold temperature values for the detected temperature of the magnetic shunt alloy.

16. The fixing device according to claim 13, wherein the controller is configured to reduce the power supplied to the inductive heater in stages corresponding to a plurality of threshold temperature values, each lower than the first threshold temperature value, for the detected temperature of the magnetic shunt alloy.

17. The fixing device according to claim 13, wherein the inductive heater comprises a coil and a ferrite core, the coil being disposed between the ferrite core and the fixing belt.

18. The fixing device according to claim 13, wherein the thermostat comprises a bimetal component.

19. An image forming method executed by an image forming apparatus that comprises a fixing device including bimetal thermostat contacting a magnetic shunt alloy adjacent to a fixing belt and a thermistor contacting the magnetic shunt alloy, the method comprising:
heating the fixing belt using an inductive heater that induces a current in the magnetic shunt alloy;
detecting a temperature of the magnetic shunt alloy on at an inner side of the fixing belt using the thermistor; and
reducing the power supplied to inductive heater when the detected temperature of the magnetic shunt alloy is equal to or higher than a first threshold temperature value that is lower than a second threshold temperature value at which the thermostat is configured to shut off power to the inductive heater.

20. The method according to claim 19, further comprising:
lowering a rotation speed of the fixing belt when the detected temperature of the magnetic shunt alloy reaches the first threshold temperature value.
